(19) United States
(12) Patent Application Publication
(10) Pub. No.: US 2009/0249330 A1
(43) Pub. Date: Oct. 1, 2009

(54) METHOD AND APPARATUS FOR HYPERVISOR SECURITY CODE

(76) Inventors: David K. Abercrombie, Alpharetta, GA (US); Aaron C. Brown, Austin, TX (US); Robert G. Kovacs, Austin, TX (US); Renato J. Recio, Austin, TX (US)

Correspondence Address: IBM Corp. (AUS/RCR);c/o The Rolnik Law Firm, P.C., 24 N. Main St., Kingwood, TX, 77339, US

(21) Appl. No.: 12/058,907

(22) Filed: Mar. 31, 2008

(51) Int. Cl. G06F 9/455; G06F 15/16

(52) U.S. Cl. 718/1; 709/238

(57) ABSTRACT

Disclosed is a computer implemented method, apparatus, and computer program product for regulating received data in a multiple operating system environment on an I/O adapter. The method includes a hypervisor for determining that the I/O adapter indicated a receive completion. The hypervisor, responsive to retrieving the receive completion, determines that the receive completion is associated with a successful status. The hypervisor, determines in hypervisor space whether an at least one data packet satisfies a security criterion. The hypervisor, routes the data packet to at least one selected from a group consisting of an operating system partition of the multiple operating system environment and a network address on a local area network.

### BACKGROUND OF THE INVENTION

1. Field of the Invention

The present invention relates generally to maintaining the security and integrity of a data processing system. More specifically, the present invention relates to a computer implemented method, apparatus, and computer program product for placing security code in a hypervisor or virtual machine monitor.

2. Description of the Related Art

Virtualization is the creation of substitutes for real resources. The substitutes have the same functions and external interfaces as their physical counterparts, but differ in attributes, such as size, performance, and cost. These substitutes are called virtual resources, and their users are typically unaware of the substitution. Virtualization is commonly applied to physical hardware resources by combining multiple physical resources into shared pools from which users receive virtual resources. With virtualization, a computer system administrator can make one physical resource look like multiple virtual resources.

A key software component supporting virtualization is the hypervisor. A hypervisor is used to logically partition the hardware into pools of virtualized resources known as logical partitions. Such logical partitions are made available to client entities, for example, operating systems and applications. Each logical partition of the hypervisor is unable to access resources of a second logical partition unless such resources are reassigned by the hypervisor.

Within a logical partition, an operating system may be stored. An OS partition is a logical partition in which an operating system is stored and executes. An operating system is used to perform basic tasks such as controlling and allocating memory, prioritizing system requests, controlling input and output devices, facilitating networking, and managing file systems. Such tasks are limited to the extent that the hypervisor allocates resources to the operating system. Such resources include memory, processing cores, input output devices, and file storage, and the like. When instantiated within a logical partition, an operating system is called an operating system partition or OS partition.

In addition to resources enumerated above, a hypervisor may allocate I/O adapters. An I/O adapter is a physical network interface that provides memory-mapped input/output interface for placing queues into physical memory and provides an interface for control information. Control information can be, for example, a selected interrupt to generate when a data packet arrives. A data packet is a formatted block of data carried by a computer or communication network. A core function of the I/O adapter is handling the physical signaling characteristics of the network media and converting the signals arriving from the network to logical values. Depending on the type of I/O adapter, additional functional layers of the Open Systems Interconnection (OSI) model protocol stack may be handled within the I/O adapter, for example, the data link layer functions and the network layer functions, among others. In contrast, higher-level communication functions may be performed by the operating system to which the I/O adapter is assigned, or by applications within the operating system.

Servers are particularly dependent on the operation of I/O adapters to accomplish the functions of a server. In addition to providing data to users across a network, servers can draw attacks by malicious and unauthorized people. Consequently, administrators can feel an acute need to protect against various exploits. As a result, administrators can install security software to improve availability of server data for authorized use. Assuring continuous availability of such servers and data entails the operation of a security module or other apparatus to examine inbound streams for threatening software. A security module can also examine inbound streams for behavior that maliciously monopolizes resources. Prior art organized systems placed a security module in the operating system.

However, such an organization includes attendant drawbacks in a virtualized data processing system. For example, a packet arriving at an I/O adapter uses resources assigned by a hypervisor or virtual machine monitor. The architecture determines a correct operating system for which the packet is destined. Next, the hypervisor orchestrates a context switch and other processor intensive operations to permit the operating system process threads to operate. One thread type is the thread for the security module running on top of the operating system. Once the security module analyzes an initial packet and approves further interaction with the packet source, further context switches occur to get the I/O adapter to respond.

Another drawback is that multiple operating systems can host a security module. Upgrades to the security modules of a hardware platform can entail uploading, installing and configuring distinct security modules. Nevertheless, the security module code can be identical among the several operating systems of the hardware platform.

Accordingly, it would be helpful if the daily operation of the hypervisor could more efficiently handle inbound packet streams in coordination with the supported operating system. In addition, it would be helpful to simplify the occasional security upgrades as new software threats become known.

### SUMMARY OF THE INVENTION

The present invention provides a computer implemented method, apparatus, and computer program product for regulating received data in a multiple operating system environment on an I/O adapter. The method includes a hypervisor for determining that the I/O adapter indicated a receive completion. The hypervisor, responsive to retrieving the receive completion, determines that the receive completion is associated with a successful status. The hypervisor, determines in hypervisor space, whether at least one data packet satisfies a security criterion. The hypervisor, routes the data packet to at least one selected from a group consisting of an operating system partition of the multiple operating system environment and a network address on a local area network.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in accordance with an illustrative embodiment of the invention;

FIG. 2 is a block diagram of software and hardware components of a data processing system of the prior art;

FIG. 3 is a block diagram of a data processing system in accordance with an illustrative embodiment of the invention;

FIG. 4 is a block diagram of a data processing system in accordance with another illustrative embodiment of the invention;

FIG. 5 is a flowchart of steps to configure and allocate software components in a data processing system in accordance with an illustrative embodiment of the invention;

FIG. 6 is a flowchart of steps performed by a hypervisor hosting a security sensor module in accordance with an illustrative embodiment of the invention; and

FIG. 7 is a flowchart of steps performed by a hypervisor upon successfully completing a receive operation in accordance with an illustrative embodiment of the invention.

### DETAILED DESCRIPTION OF THE PREFERRED EMBODIMENT

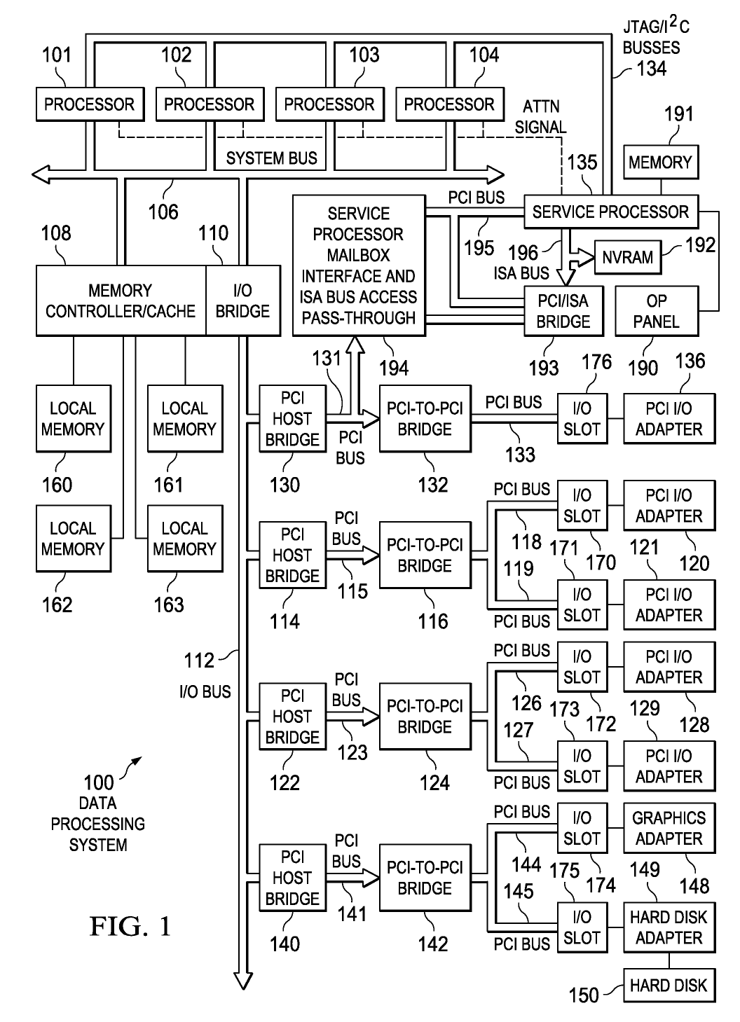

FIG. 1 shows a block diagram of a data processing system in which illustrative embodiments of the invention may be implemented. Data processing system 100 may be a symmetric multiprocessor (SMP) system including a plurality of processors 101, 102, 103, and 104, which connect to system bus 106. For example, data processing system 100 may be an IBM eServer, a product of International Business Machines Corporation in Armonk, N.Y., implemented as a server within a network. Alternatively, a single processor system may be employed. Also connected to system bus 106 is memory controller/cache 108, which provides an interface to a plurality of local memories 160-163. I/O bus bridge 110 connects to system bus 106 and provides an interface to I/O bus 112. Memory controller/cache 108 and I/O bus bridge 110 may be integrated as depicted.

Data processing system 100 is a logical partitioned (LPAR) data processing system. Thus, data processing system 100 may have multiple heterogeneous operating systems or multiple instances of a single operating system running simultaneously. Each of these multiple operating systems may have any number of software programs executing within it. Data processing system 100 is logically partitioned such that different PCI I/O adapters 120-121, 128-129, and 136, graphics adapter 148, and hard disk adapter 149 may be assigned to different logical partitions. In this case, graphics adapter 148 connects a display device (not shown), while hard disk adapter 149 connects to and controls hard disk 150.

Thus, for example, suppose data processing system 100 is divided into three logical partitions, P1, P2, and P3. Each of PCI I/O adapters 120-121, 128-129, 136, graphics adapter 148, hard disk adapter 149, each of processors 101-104, and memory from local memories 160-163 is assigned to each of the three partitions. In these examples, local memories 160-163 may take the form of dual in-line memory modules (DIMMs). DIMMs are not normally assigned on a per DIMM basis to partitions. Instead, a partition will get a portion of the overall memory seen by the platform. For example, processors 102-103, some portion of memory from local memories 160-163, and PCI I/O adapters 121 and 136 may be assigned to logical partition P2; and processor 104, some portion of memory from local memories 160-163, graphics adapter 148 and hard disk adapter 149 may be assigned to logical partition P3.

Each operating system executing within data processing system 100 is assigned to a different logical partition. Thus, each operating system executing within data processing system 100 may access only those I/O units that are within its logical partition. Thus, for example, one instance of the Advanced Interactive Executive (AIX®) operating system may be executing within partition P1, a second instance or image of the AIX® operating system may be executing within partition P2, and a Linux® operating system may be operating within logical partition P3. AIX® is a registered trademark of International Business Machines Corporation. Linux® is a registered trademark of Linus Torvalds.

Peripheral component interconnect (PCI) host bridge 114 connected to I/O bus 112 provides an interface to PCI local bus 115. A number of PCI input/output adapters 120-121 connect to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations support between four and eight I/O adapters, that is, expansion slots for add-in connectors. Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 connects to a plurality of PCI I/O adapters 128-129. PCI I/O adapters 128-129 connect to PCI bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. Consequently, data processing system 100 allows connections to multiple network computers.

A memory mapped graphics adapter 148 is inserted into I/O slot 174 and connects to I/O bus 112 through PCI bus 144, PCI-to-PCI bridge 142, PCI bus 141, and PCI host bridge 140. Hard disk adapter 149 may be placed into I/O slot 175, which connects to PCI bus 145. In turn, this bus connects to PCI-to-PCI bridge 142, which connects to PCI host bridge 140 by PCI bus 141.

A PCI host bridge 130 provides an interface for a PCI bus 131 to connect to I/O bus 112. PCI I/O adapter 136 connects to I/O slot 176, which connects to PCI-to-PCI bridge 132 by PCI bus 133. PCI-to-PCI bridge 132 connects to PCI bus 131. This PCI bus also connects PCI host bridge 130 to the service processor mailbox interface and ISA bus access pass-through logic 194 and PCI-to-PCI bridge 132. Service processor mailbox interface and ISA bus access pass-through logic 194 forwards PCI accesses destined to the PCI/ISA bridge 193. NVRAM storage 192, also known as non-volatile RAM, connects to the ISA bus 196. Service processor 135 connects to service processor mailbox interface and ISA bus access pass-through logic 194 through its local PCI bus 195. Service processor 135 also connects to processors 101-104 via a plurality of JTAG/I²C busses 134. JTAG/I2C busses 134 are a combination of JTAG/scan busses, as defined by Institute for Electrical and Electronics Engineers standard 1149.1, and Philips I²C busses. However, alternatively, JTAG/I²C busses 134 may be replaced by only Philips I²C busses or only JTAG/scan busses. All SP-ATTN signals of the processors 101, 102, 103, and 104 connect together to an interrupt input signal of service processor 135. Service processor 135 has its own local memory 191 and has access to the hardware OP-panel 190.

When data processing system 100 is initially powered up, service processor 135 uses the JTAG/I²C busses 134 to interrogate the system processors 101-104, memory controller/cache 108, and I/O bridge 110. At the completion of this step, service processor 135 has an inventory and topology understanding of data processing system 100. Service processor 135 also executes Built-In-Self-Tests (BISTs), Basic Assurance Tests (BATs), and memory tests on all elements found by interrogating processors 101-104, memory controller/cache 108, and I/O bridge 110. Any error information for failures detected during the BISTs, BATs, and memory tests are gathered and reported by service processor 135.

If a meaningful or valid configuration of system resources is still possible after taking out the elements found to be faulty during the BISTs, BATs, and memory tests, then data processing system 100 is allowed to proceed to load executable code into local memories 160-163. Service processor 135 then releases processors 101-104 for execution of the code loaded into local memory 160-163. While processors 101-104 are executing code from respective operating systems within data processing system 100, service processor 135 enters a mode of monitoring and reporting errors. The type of items monitored by service processor 135 includes, for example, the cooling fan speed and operation, thermal sensors, power supply regulators, and recoverable and non-recoverable errors reported by processors 101-104, local memories 160-163, and I/O bridge 110.

Service processor 135 saves and reports error information related to all the monitored items in data processing system 100. Service processor 135 also takes action based on the type of errors and defined thresholds. For example, service processor 135 may take note of excessive recoverable errors on a processor's cache memory and determine that this condition is predictive of a hard failure. Based on this determination, service processor 135 may mark that processor or other resource for deconfiguration during the current running session and future Initial Program Loads (IPLs). IPLs are also sometimes referred to as a “boot” or “bootstrap.”

Data processing system 100 may be implemented using various commercially available computer systems. For example, data processing system 100 may be implemented using IBM eServer iSeries Model 840 system available from International Business Machines Corporation. Such a system may support logical partitioning, wherein an OS/400® operating system may exist within a partition. OS/400 is a registered trademark of International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example does not imply architectural limitations with respect to the present invention.

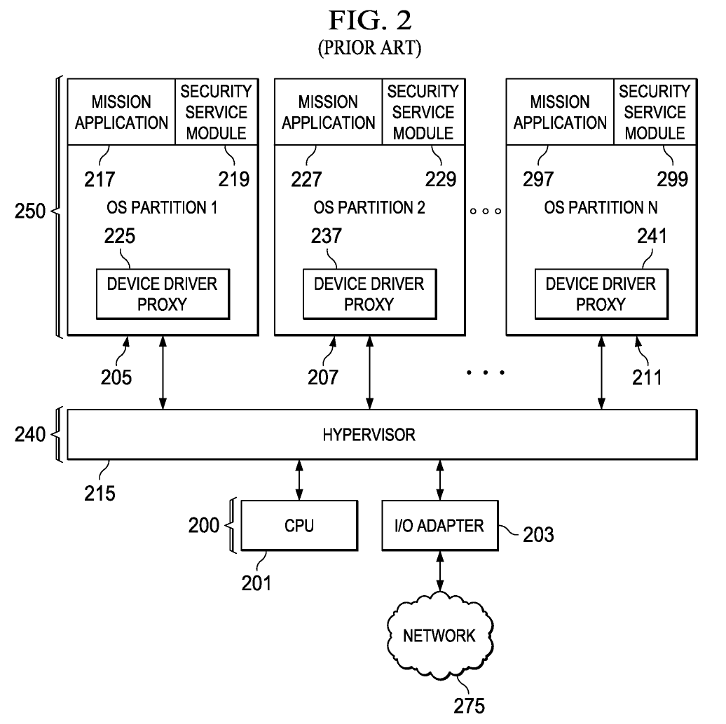

FIG. 2 shows software and hardware components of a data processing system of the prior art. The data processing system can rely on hardware in hardware layer 200, for example, central processor unit (CPU) 201 and I/O adapter 203. The data processing layer can include, for example, data processing system 100 of FIG. 1. In particular, processor unit 201 and I/O adapter 203 can be processor 101 and PCI I/O adapter 136, respectively of FIG. 1.

Hardware layer 200 directly supports hypervisor 215. Hypervisor occupies memory in hypervisor space 240. A hypervisor space is a memory allocated to virtual machine management functions. Consequently, the hypervisor space stores program instructions and data of the hypervisor. As such, code resident in the hypervisor space is not amenable to re-allocation into the pool of virtual resources made available to the several operating systems that occupy several logical partitions above hypervisor space 240. The data processing system relies on security features supported in user space or kernel space 250.

The prior art data processing system can organize three operating systems into operating system (OS) partition 1 205, OS partition 2 207 and OS partition N 211, each supporting device driver proxy 225, device driver proxy 237, and device driver proxy 241, respectively. Within user space or kernel space 250, OS partition 1 205 supports mission application 217. A mission application is data and computer program instructions for an application that achieves a business objective, for example, a database program such as Oracle® relational database management system. Oracle is a trademark of Oracle Corporation. Security service module 219 of the prior art provides security functions in order to preserve the integrity and availability of mission application 217. Likewise, mission application 227 and security service module 229 provide business objective function and integrity functions within OS partition 2 207. Similarly, mission application 297 and service security module 299 provide business objective function and integrity functions within OS partition N 211. Consequently, data streams (which may contain malevolent code) arriving via network 275 at I/O adapter 203 are treated by security service module 219 prior to entry and use by mission application 217.

The illustrative embodiments of the invention regulate received data in a multiple operating system environment. Integrated security within a server that houses multiple operating systems improves efficiency. Accordingly, at least one embodiment of the invention is implemented in the hypervisor to send the I/O data traffic to a security sensor application shared by the multiple operating system (OS) partitions. If the security sensor application indicates that the I/O data traffic meets pre-defined security standards in the security sensor application, it routes the data packet to at least one selected from a group consisting of an operating system partition of the multiple operating system environment and a network address on a local area network. Consequently, inefficient loading of security code to multiple partitions is avoided, while preserving the security functions of the security code.

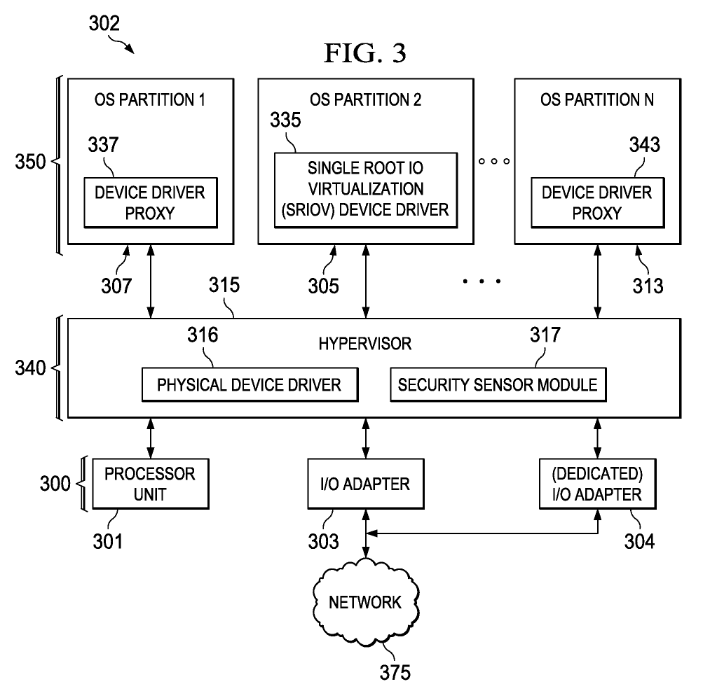

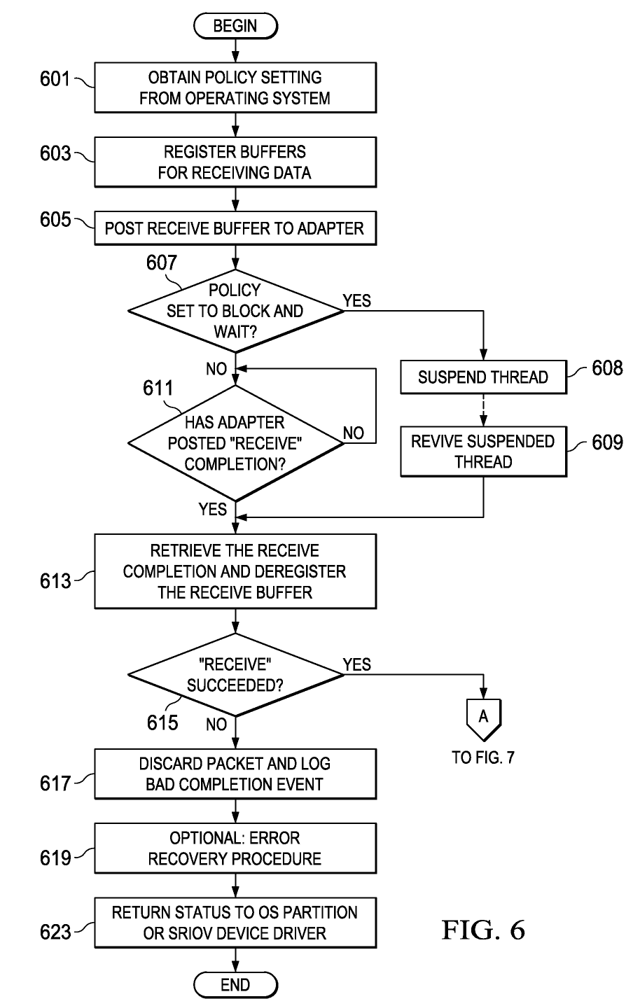

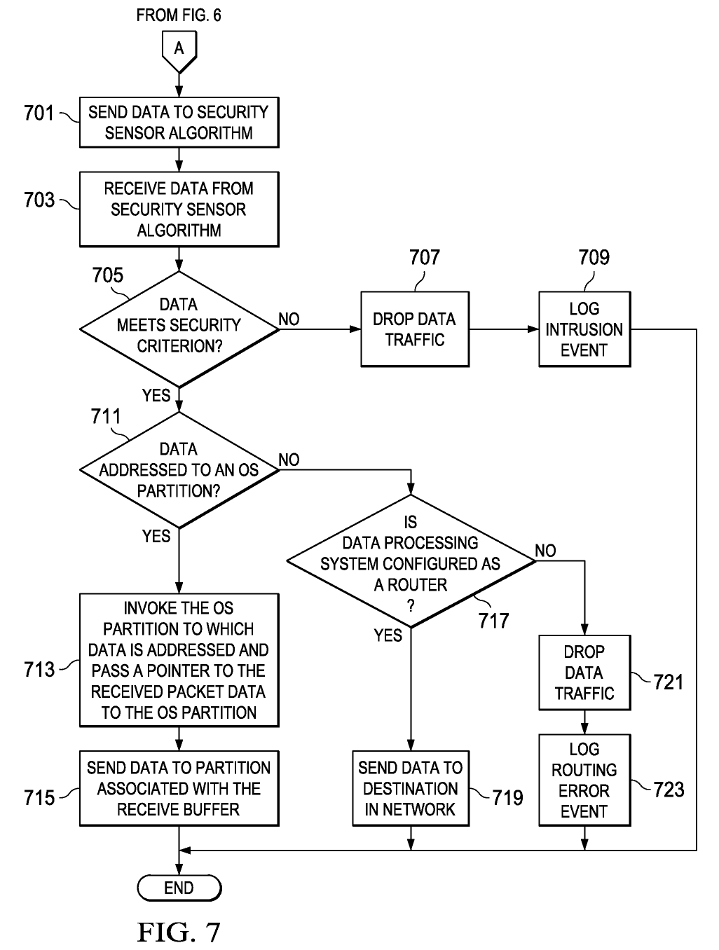

FIG. 3 is a block diagram of a data processing system in accordance with an illustrative embodiment of the invention. The security sensor module 317 may be made up of security code. Security code is at least the code that can instruct one or more microprocessors to execute the steps of FIGS. 6 and 7, explained further below. Such steps may be embodied in computer program instructions stored to computer readable media or loaded into hypervisor space. Data processing system 302 communicates via network 375. An underlying hardware layer 300 supports software components above it. The hardware layer can be, for example, data processing system 100 of FIG. 1. Some hardware elements are shown here, while others are not shown for clarity.

A hypervisor allocates hardware among the various software components. For example, the hypervisor is configured to allocate resources to an operating system, thus forming an OS partition. A multiple operating system environment is a data processing system having an executing hypervisor. The capacity to allocate resources to two or more operating systems is a feature of a multiple operating system environment. Processor unit 301 is allocated among the various software components by hypervisor 315. Similarly, I/O adapter 303 is also allocated among the various software components. I/O adapter 303 receives packets from and sends packets to network 375. Network 375 can be a local area network or the Internet. A local area network (LAN) is a network that transmits and receives data in a local area. A LAN can be, for example, Ethernet, Wi-Fi, ARCNET, or token ring, among others. In addition, the transport medium of network 375 can be either wired, wireless, or a combination thereof.

In addition to supporting basic partitioning functions of data processing system 302, hypervisor 315 hosts security sensor module 317 within hypervisor space 340. Hypervisor 315 also hosts physical device driver 316, which is used by OS partitions to access and share a physical adapter, for example, I/O adapter 303. Additionally, the Hypervisor security sensor module hosts security code. Security code is resident within security sensor module 317.

Hypervisor 315 may contain a virtual Ethernet switch which can be used to communicate between OS partitions resident above hypervisor 315. Hypervisor 315 can transmit packets by copying the packet directly from the memory of the sender partition to the receive buffers of the receiver partition without any intermediate buffering of the packet. For this virtual Ethernet switch case, before copying the data, hypervisor 315 invokes the security sensor algorithm 701 of FIG. 7, below, to perform the security check.

Data processing system 302 is shown with three partitions: OS partition 1 307, OS partition 2 305, and OS partition N 313. Each partition may operate in relative isolation as related to an adjacent partition. That is, one partition cannot directly access the memory of a second partition, except by security and authorization functions of the hypervisor and of the second partition.

A first partition may be OS partition 1 307. The OS partition 1 may support a mission application (not shown). Within OS partition 1 307, device driver proxy 337 receives high-level communication requests (both inbound and outbound) from the mission application. A device driver proxy provides an upstream device driver interface to all operating system components that need to access the physical I/O adapter 303 through device driver proxy 337. However, device driver proxies do not directly access I/O adapters. Instead, a device driver proxy uses, for example, physical device driver 316 to transmit and receive all data communicated through I/O adapter 303.

A second partition may be OS partition 2 305. Like the OS partition 1, the OS partition 2 may support a mission application (not shown). OS partition 2 305 hosts single root 10 virtualization (SRIOV) device driver 335.

A third partition may be OS partition N 313. Like the OS partition 1 307, the OS partition N 313 may support a mission application (not shown). OS partition N 313 hosts device driver proxy 343, which uses the hypervisor's device driver, physical device driver 316, to communicate with I/O adapter 304.

I/O adapter 303 may be shared between two partitions, namely, OS partition 1 307, OS partition 2 305. In contrast, I/O adapter 304 is dedicated to OS partition N 313.

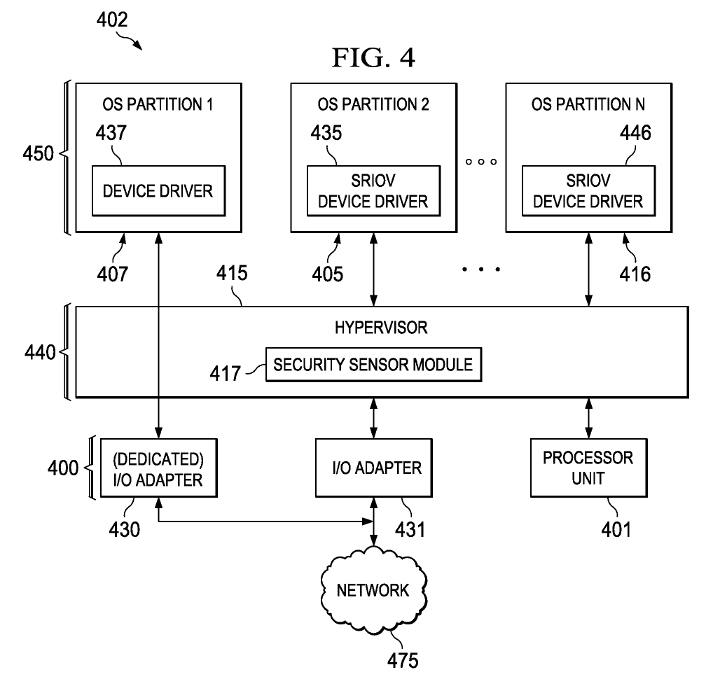

FIG. 4 is a block diagram of a data processing system in accordance with another illustrative embodiment of the invention. Security sensor module 417 includes security code. Data processing system 402 communicates via network 475. Hardware layer 400 supports software components above it. Such software components are resident within user space or kernel space 450 as well as hypervisor space 440. The hardware layer can include, for example, data processing system 100 of FIG. 1. Some hardware elements are shown here, while others are not shown for clarity. Data processing system 402 supports three partitions: OS partition 1 407, OS partition 2 405 and OS partition N 416.

The hypervisor allocates hardware among the various software components. For example, the hypervisor is configured to allocate resources to an operating system, thus forming an OS partition. Processor unit 401 is allocated among the various software components by hypervisor 415. Similarly, I/O adapter 431 is allocated among OS partition 2 405 and OS partition N 416. Hypervisor 415 allocates I/O adapter 430 exclusively to OS partition 1 407.

In addition to supporting basic partitioning functions of data processing system 402, hypervisor 415 hosts security sensor module 417. The security sensor module hosts security code. Security code is resident within security sensor module 417.

A first partition may be OS partition 1 407. The OS partition 1 may support a mission application (not shown). Within OS partition 1 407, a device driver 437 receives high-level communication requests (both inbound and outbound) from the mission application and communicates directly with I/O adapter 430. However, before device driver 437 passes any received data to the requesting application, it invokes hypervisor 415's security sensor module 417 to perform the security sensor algorithms.

A second partition may be OS partition 2 405. Like the OS partition 1, the OS partition 2 may support a mission application (not shown). OS partition 2 405 hosts Single Root I/O Virtualization (SRIOV) device driver 435, which is used to communicate directly with shared I/O adapter 431. I/O adapter 431 supports the single root I/O virtualization functions.

A third partition may be OS partition N 416. Like the OS partition 1 407, OS partition N 416 may support a mission application (not shown). OS partition N 416 hosts device driver 446, which is used to communicate directly with shared I/O adapter 431.

I/O adapter 430 is dedicated to OS partition 1 407. I/O adapter 431 is shared by OS partition 2 405 and OS partition N 416.

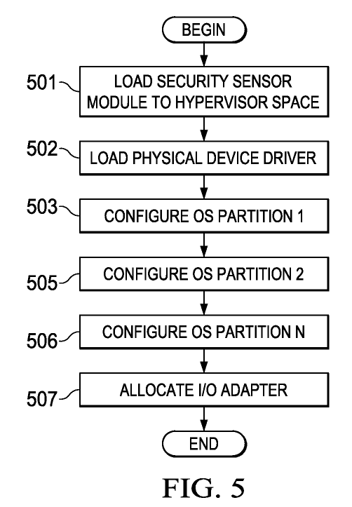

FIG. 5 is a flowchart of steps to configure and allocate software components in a data processing system in accordance with an illustrative embodiment of the invention. Initially, a hypervisor or a basic input/output system (BIOS) loads a security sensor module to hypervisor space (step 501). The hypervisor may also load the physical device driver to hypervisor space (step 502). The hypervisor may be hypervisor 315 and data processing system 302 of FIG. 3. Next, the hypervisor may configure first OS partition 1 (step 503). Next, the hypervisor may configure second OS partition 2 (step 505). In addition, the hypervisor may configure OS partition N (step 506). Next, the hypervisor may allocate an I/O adapter (step 507). For example, the hypervisor may be hypervisor 315, and the first OS partition may be OS partition 1 307 and the second OS partition may be OS partition 2 305, of FIG. 3. In allocating the I/O adapter, the hypervisor may allocate the I/O adapter as a dedicated I/O adapter, for example, I/O adapter 430 in FIG. 4. Alternatively, the hypervisor may allocate the I/O adapter as a shared resource between two or more partitions. In the second case, the hypervisor may mediate between the software components that contend for use of the I/O adapter. Processing terminates thereafter. At this point, the data processing system may be configured. It is appreciated that the hypervisor may execute steps of FIG. 5, with the exception of step 502, to configure partitions and other components as in data processing system 402 of FIG. 4.

FIG. 6 is a flowchart of steps performed by a hypervisor as described in FIG. 3 for hosting a security sensor module in accordance with an illustrative embodiment of the invention. Upon each receive invocation, the OS partition invoking the hypervisor will select whether to perform the operation as a “block and wait”. Alternatively, the OS partition invoking the hypervisor may select that the I/O adapter operate on the basis of an interrupt signal. Consequently, the hypervisor obtains the policy setting from the OS partition. The type of operation may be established by a bit set in the receive invocation between the hypervisor and the OS partition.

Attendant with invocation, the OS partition makes available one or more buffers for use in receiving data. The hypervisor is responsible for translating the addresses of these buffers from the OS partition's memory space into the memory space used by the adapter to access system memory. This process known as registering buffers for receiving data (step 603). Step 603 may also be known as registration. Next, the hypervisor posts the receive buffer to the I/O adapter (step 605). Step 605 may involve pinning the buffer so that it does not get paged out. Step 605 may also include posting a “receive work request.”

Next, the hypervisor may determine whether the policy is set to block and wait (step 607). If not, the hypervisor polls the I/O adapter to determine whether the adapter has posted a “receive completion” (step 611). However, a positive result to step 607 may mean that the OS invoked the hypervisor with an interrupt driven policy. If that is the case, the hypervisor may suspend operation, and release the processing resources until an interrupt occurs. In that case, the processor suspends the thread (step 608) and revives the suspended thread (step 609) in response to detecting an interrupt that signals a completion.

Next, following either step 609 or step 611, the hypervisor retrieves the “receive completion” and deregisters the buffers used for the receive (step 613). A receive completion may be implemented such that the I/O adapter writes to a control bit. In such an implementation, the hypervisor may read the control bit to determine if a new completion has been posted. Deregistration is the process of unpinning the previously pinned buffers. The receive completion includes data that indicates either a successful completion or a failed completion. The hypervisor may determine whether the “receive” succeeded (step 615). Provided the “receive” did not succeed, the hypervisor discards the packet and logs a bad completion event (step 617). Next, the hypervisor may perform an error recovery procedure (step 619). Next, the hypervisor returns the receive error status to an applicable OS partition, or single root I/O virtualized (SRIOV) device driver (step 623). A receive status is a binary indication of whether the “receive” succeeded. The receive status can be a successful status or an unsuccessful status. A successful status is a predetermined bit setting used to indicate a successful receive. The receive status may include, for example, a result from an optional error recovery procedure such as step A from FIG. 7. An unsuccessful status is a predetermined bit setting that is a complement of the successful status. Processing terminates thereafter.

The hypervisor may obtain further analysis of a received packet stream by coordinating with software components inside or outside the hypervisor. A positive result to step 615 causes the hypervisor to pass a pointer to the received data to the security sensor algorithm (SSA). Sending may occur via inter-process communication.

A security sensor algorithm (SSA) is computer program instructions that detect inbound and/or outbound attacks. In addition, the SSA is used to perform intrusion monitoring and analysis, such as, to detect attacks that span multiple packets. An intrusion detection computer program instruction is any instruction of a program that detects or otherwise monitors one or more packets, wholly or in derivative form, for hostile content. Similarly, an intrusion prevention computer program instruction is any instruction of a program that quarantines, disables, deletes, or otherwise ameliorates the impact of hostile content within one or more packets. A security sensor algorithm (SSA) computer program instruction is an intrusion detection computer program instruction and/or an intrusion prevention computer program instruction. The SSA can detect network-level attacks. In addition, the SSA can use signature-based methods to detect attacks. The SSA can reside in one of several locations of a data processing system, for example, data processing system 302 of FIG. 3. These memory locations can be, for example, within OS partition 1 307, OS partition 2 305 and the security sensor module 317. “Reside” or “resident” means that computer program instructions of the SSA are stored or loaded to memory allocated to the software component to which the program is said to reside.

FIG. 7 is a flowchart of steps performed by a hypervisor upon successfully completing a receive operation in accordance with an illustrative embodiment of the invention. Initially, the hypervisor sends data to a security sensor algorithm (SSA) (step 701). The SSA may be resident, for example, within user space or kernel space 350 of FIG. 3. For example, the SSA can be hosted within OS partition 1 307, OS partition 2 305, or OS partition N 313. In addition, the SSA can be hosted within OS partition N 416 of FIG. 4. Alternatively, the SSA may be resident within security sensor module 317 of FIG. 3.

Next, the hypervisor receives data from the SSA (step 703). The data may comprise one or more bits to indicate status of the packets in the receive buffer. Such a status can indicate, for example, whether the data meets a security standard, or whether the received packet data is addressed to an OS partition.

Next, the hypervisor determines whether the received packet data meets a security criterion (step 705). A security criterion is a pre-determined test that indicates that one or more packets are considered low risk, as compared to packets that have patterns associated with data processing system exploits. The test can include matching to a pattern in packets derived from a virus known to damage or otherwise compromise a data processing system. A hypervisor can evaluate the bit to make a final determination whether a data packet or data packets satisfy the security criterion. The hypervisor may make this determination by evaluating one or more bits set by the SSA attendant with step 703. A negative determination causes the hypervisor to drop traffic data (step 707). The hypervisor may drop traffic data, for example, by not passing the data to the OS partition that invoked the hypervisor. Next, the hypervisor may log an intrusion event (step 709). Processing terminates thereafter.

However, if the hypervisor determines that the received packet data meets a security standard, the hypervisor may further determine if data is addressed to an OS partition of the data processing system (step 711).

A positive determination results in the hypervisor invoking the OS partition to which data is addressed and passing a pointer of the received packet data to the OS partition (step 713). Next, the security sensor may send data to the partition associated with the receive buffer (step 715). Processing terminates thereafter.

On the other hand, a negative determination to step 711 results in the hypervisor determining whether the data processing system is configured as a router (step 717). A positive determination causes the hypervisor to send the received packet data to a destination in the network (step 719). The destination can be a network address. A network address is an address that uniquely identifies a device. A network address can include an identifier of a host network. Network addresses include, for example, Media Access Control (MAC) addresses, Internet Protocol (IP) addresses and X.25 addresses, among others. Processing terminates thereafter. However, a negative determination to step 717 causes the hypervisor to drop the received packet data (step 721). The hypervisor may log the routing error event (step 723). Processing terminates thereafter.

Thus, a hypervisor arranged in accordance with one or more embodiments of the invention may coordinate with SSA within the hypervisor or located in user space or kernel space. Such coordination may achieve some efficiency by reducing the number of context switches to securely process received packet traffic. In addition, upgrades to packet security among several operating system partitions may be performed in a single replacement of code in a security sensor module of the hypervisor.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for regulating received data in a multiple operating system environment on an I/O adapter, the method comprising:
determining that the I/O adapter indicated a receive completion;
responsive to a determination that the I/O adapter indicated the receive completion, retrieving the receive completion;
responsive to retrieving the receive completion, determining that the receive completion is associated with a successful status;
determining in hypervisor space whether an at least one data packet satisfies a security criterion; and
routing the data packet to at least one selected from a group consisting of an operating system partition of the multiple operating system environment and a network address on a local area network.

2. The computer implemented method of claim 1, further comprising:
loading security code to the hypervisor space;
configuring at least two operating system partitions within the multiple operating system environment; and
allocating the I/O adapter to at least one operating system partition.

3. The computer implemented method of claim 2, wherein security code does not include security sensor algorithm computer program instructions.

4. The computer implemented method of claim 2, wherein security code includes security sensor algorithm computer program instructions.

5. The computer implemented method of claim 4, wherein security sensor algorithm computer program instructions comprise:
at least one computer program instruction selected from a group consisting of an intrusion detection computer program instruction and an intrusion prevention computer program instruction.

6. The computer implemented method of claim 4, wherein the I/O adapter is allocated to at least one device driver proxy.

7. The computer implemented method of claim 4, wherein the I/O adapter is allocated to at least one single root I/O virtualization device driver.

8. A data processing system comprising:
a bus;
a storage device connected to the bus, wherein computer usable code is located in the storage device;
a communication unit connected to the bus; and
a processing unit connected to the bus, wherein the processing unit executes the computer usable code for regulating received data in a multiple operating system environment on an I/O adapter, the processing unit further executes the computer usable code to determine that the I/O adapter indicated a receive completion; responsive to a determination that the I/O adapter indicated the receive completion, retrieve the receive completion; responsive to retrieving the receive completion, determine that the receive completion is associated with a successful status; determine in hypervisor space whether an at least one data packet satisfies a security criterion; and route the data packet to at least one selected from a group consisting of an operating system partition of the multiple operating system environment and a network address on a local area network.

9. The data processing system of claim 8, wherein the processing unit further executes the computer usable code to load security code to the hypervisor space; configure at least two operating system partitions within the multiple operating system environment; and allocate the I/O adapter to at least one operating system partition.

10. The data processing system of claim 9 wherein security code does not include security sensor algorithm computer program instructions.

11. The data processing system of claim 9, wherein security code includes security sensor algorithm computer program instructions.

12. The data processing system of claim 11, wherein security sensor algorithm program instructions comprise:
at least one computer instruction selected from a group consisting of an intrusion detection program instruction and an intrusion prevention program instruction.

13. The data processing system of claim 11, wherein the I/O adapter is allocated to at least one device driver proxy.

14. The data processing system of claim 11, wherein the I/O adapter is allocated to at least one single root I/O virtualization device driver.

15. A computer program product for regulating received data in a multiple operating system environment on an I/O adapter, the computer program product comprising:
computer usable program code for determining that the I/O adapter indicated a receive completion;
computer usable program code for retrieving the receive completion, responsive to a determination that the I/O adapter indicated the receive completion;
computer usable program code for determining that the receive completion is associated with a successful status, responsive to retrieving the receive completion;
computer usable program code for determining in hypervisor space whether an at least one data packet satisfies a security criterion; and
computer usable program code for routing the data packet to at least one selected from a group consisting of an operating system partition of the multiple operating system environment and a network address on a local area network.

16. The computer program product of claim 15, further comprising
computer usable program code for loading security code to the hypervisor space;
configuring at least two operating system partitions within the multiple operating system environment; and
computer usable program code for allocating the I/O adapter to at least one operating system partition.

17. The computer program product of claim 16, wherein security code does not include security sensor algorithm computer program instructions.

18. The computer program product of claim 16, wherein security code includes security sensor algorithm computer program instructions.

19. The computer program product of claim 18, wherein security sensor algorithm computer program instructions comprise:
at least one computer program instruction selected from a group consisting of an intrusion detection computer program instruction and an intrusion prevention computer program instruction.

20. The computer program product of claim 18, wherein the I/O adapter is allocated to at least one device driver proxy.
